(19) United States
(12) Patent Application Publication
(10) Pub. No.: US 2010/0158601 A1
(43) Pub. Date: Jun. 24, 2010

(54) Swing Pin Assembly And Associated Method

(75) Inventors: Jose G. Salas Madrid, Garner, NC (US); Michael T. Ryan, Cary, NC (US); David H. True, JR., Selma, NC (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/617,846

(22) Filed: Nov. 13, 2009

Related U.S. Application Data
(60) Provisional application No. 61/139,349, filed on Dec. 19, 2008.

(51) Int. Cl. F16L 27/087; B23P 11/00

(52) U.S. Cl. 403/38; 29/428

(57) ABSTRACT

A swing pin assembly including a pin body defining first and second lubricant channels, and further including a zerk mount attached to the pin body, wherein the zerk mount defines first and second zerk receptacles, a first lubricant chamber downstream from the first zerk receptacle and upstream from the first lubricant channel, and a second lubricant chamber downstream from the second zerk receptacle and upstream from the second lubricant channel.

### CROSS-REFERENCE TO RELATED APPLICATION

This application claims the benefit of the filing date of, and for all other purposes claims priority to, U.S. Provisional Patent Application Ser. No. 61/139,349, filed on Dec. 19, 2008 and entitled “SWING PIN ASSEMBLY AND ASSOCIATED METHOD”.

### TECHNICAL FIELD

This invention generally relates to a swing pin assembly and a method for assembling the swing pin assembly. By way of example, the swing pin assembly may be installed in a swing mechanism of a boom of an earthmoving machine such as an excavator or backhoe loader to help enable the boom to swing along a substantially arcuate path in response to manipulation of boom swing controls by a human operator.

### BACKGROUND

A swing pin assembly is commonly utilized in heavy duty machinery experiencing high friction as well as high mechanical stresses and strains. As mentioned above, such machinery may include a swing mechanism of a boom on an earthmoving machine such as an excavator or backhoe loader. Depending on the load being carried by the bucket on such a machine, the associated swing pin assembly may experience high stress, strain, and friction, thereby increasing wear on the swing pin assembly and shortening its life. In addition, dirt, waste, or other foreign matter being encountered and/or moved by the machine may come into contact with the swing pin assembly, potentially exacerbating the environment in which the assembly has to operate. Proper and thorough lubrication of a swing pin assembly can help slow and reduce such wear, however the assembly must be easily accessible for lubrication and the lubrication must cover a substantial portion of the surface area of the swing pin assembly.

Many designs of swing pin assemblies, also called pivot pin assemblies, may be found in the prior art. Such designs include a wide variety of lubrication systems. For instance, U.S. Pat. No. 4,251,182 to Schroeder discloses a pivot pin assembly that includes a pivot pin with an axial bore and a cross-bore that cooperate to provide fluid communication between a lubricant reservoir and a lubricant reservoir chamber in the assembly. In addition, the reservoir and the reservoir chamber in Schroeder may be filled with lubricant through a fitting that provides access to the axial bore of the pivot pin and/or through the cross-bore of the pivot pin after a plug is removed from a bore in the boom arm that provides access to the cross-bore. However, the pivot pin assembly in Schroeder requires cooperation between bores in the boom arm and the pivot pin, provides lubricant only to a localized region of the pivot pin, and limits the ability of gravity to help distribute lubricant within the pivot pin.

### SUMMARY

A swing pin assembly including a pin body defining first and second lubricant channels, and further including a zerk mount attached to the pin body, wherein the zerk mount defines first and second zerk receptacles, a first lubricant chamber downstream from the first zerk receptacle and upstream from the first lubricant channel, and a second lubricant chamber downstream from the second zerk receptacle and upstream from the second lubricant channel.

A swing pin assembly including a pin body defining first and second lubricant channels, and further including a zerk mount attached to the pin body, wherein the zerk mount defines first and second zerk receptacles, a first lubricant chamber downstream from the first zerk receptacle and upstream from the first lubricant channel, and a second lubricant chamber downstream from the second zerk receptacle and upstream from the second lubricant channel. The zerk mount includes a first zerk receiver defining the first zerk receptacle and the first lubricant chamber and a second zerk receiver defining the second zerk receptacle and the second lubricant chamber. The second zerk receiver defines a zerk receiver port for receiving the first zerk receiver, the first zerk receiver removably engages the second zerk receiver, and the second zerk receiver removably engages the pin body.

A method for assembling a swing pin assembly, including attaching a zerk mount to a pin body defining first and second lubricant channels. The zerk mount defines first and second zerk receptacles, a first lubricant chamber downstream from the first zerk receptacle and upstream from the first lubricant channel, and a second lubricant chamber downstream from the second zerk receptacle and upstream from the second lubricant channel. The method further includes securing first and second zerks in the first and second zerk receptacles, respectively.

### BRIEF DESCRIPTION OF THE DRAWINGS

FIG. 1 is an isometric view of a swing pin assembly according to an embodiment of the invention;

FIG. 2 is an exploded view of the swing pin assembly shown in FIG. 1; and

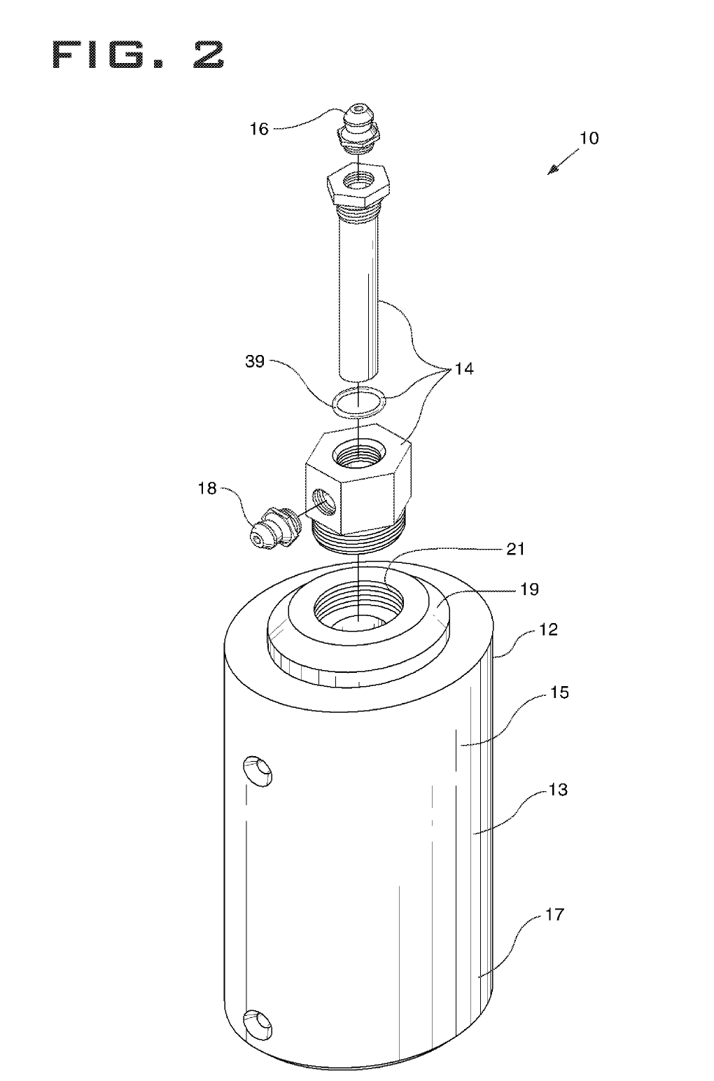

FIG. 3 is a cross-sectional view taken though line 3-3 of FIG. 1.

### DETAILED DESCRIPTION

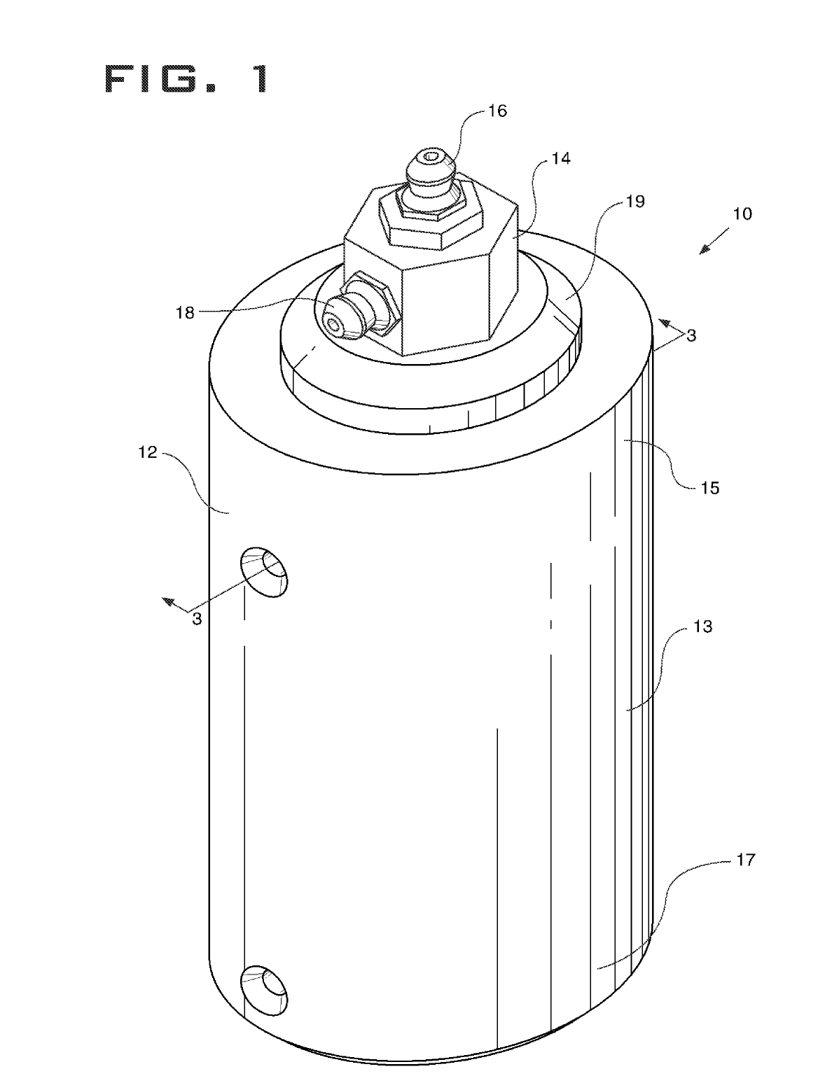

A swing pin assembly is shown broadly at reference numeral 10 in FIG. 1. The swing pin assembly 10 includes a pin body 12, a zerk mount 14, and first and second zerk fittings 16, 18. Hereinafter, in accordance with the knowledge of one of ordinary skill in the art, the term “zerk” shall be used in place of the term “zerk fitting” when referring to the one-way lubricant inlets 16, 18 of the swing pin assembly 10.

The pin body 12 includes a pin cylinder 13 having a proximal end 15 and a distal end 17 and a zerk mount base 19 mounted to or integral with the proximal end 15 of the pin cylinder 13. The zerk mount base 19 defines a zerk mount receptacle 21. The pin cylinder 13 further defines first and second lubricant channels 20, 22 and first and second pairs of lubricant outlets 26, 28. The first and second pairs of lubricant outlets 26, 28 each include a first lubricant outlet 30 coaxial with and opposing a second lubricant outlet 32. The first pair of lubricant outlets 26 is in fluid communication with the first lubricant channel 20, while the second pair of lubricant outlets 28 is in fluid communication with the second lubricant channel 22. The first pair of lubricant outlets 26 is adjacent to the proximal end 15 of the pin cylinder 13, while the second pair of lubricant outlets 28 is adjacent to the distal end 17 of the pin cylinder 13.

The zerk mount 14 is attached to the zerk mount base 19 of the pin body 12 at the zerk mount receptacle 21. The zerk mount 14 includes a first zerk receiver 34 defining a first zerk receptacle 36 and a first lubricant chamber 38. The first lubricant chamber 38 is downstream from the first zerk receptacle 36 and upstream from the first lubricant channel 20. The zerk mount 14 further includes a second zerk receiver 40 defining a second zerk receptacle 42 and a second lubricant chamber 44. The second lubricant chamber 44 is downstream from the second zerk receptacle 42 and upstream from the second lubricant channel 22. The first and second zerk receptacles 36, 42 are substantially perpendicular to one another. The first lubricant chamber 38 and the second lubricant chamber 44 are concentric and the cross-sectional area of the first lubricant chamber 38 is less than the cross-sectional area of the second lubricant chamber 44.

The first zerk receiver 34 is a hollow fastener comprising a head 46 and a shank 48. The head 46 defines the first zerk receptacle 36 while the shank 48 defines the first lubricant chamber 38. The second zerk receiver 40 is a cap-shaped fitting that includes a top wall 49 defining a zerk receiver port 50 in substantially perpendicular relation to the second zerk receptacle 42, which is defined by a side wall 51 of the second zerk receiver 40. A proximal portion 52 of the shank 48 of the first zerk receiver 34 is externally threaded to mate with an internally threaded wall 54 of the zerk receiver port 50 defined by the second zerk receiver 40. Further, a distal portion 56 of the second zerk receiver 40 is externally threaded to mate with an internally threaded wall 58 of the zerk mount receptacle 21 defined by the zerk mount base 19 of the pin body 12. The zerk mount 14 further includes a washer or gasket 39 residing around the first zerk receiver 34 in the zerk receiver port 50 defined by the second zerk receiver 40. The first zerk receiver 34 therefore removably engages the second zerk receiver 40 while the second zerk receiver 40 removably engages the pin body 12.

A method for assembling the swing pin assembly 10 includes securing the first zerk receiver 34 in the zerk receiver port 50 defined by the second zerk receiver 40, attaching the zerk mount 14 to the pin body 12, and securing the first and second zerks 16, 18 in the first and second zerk receptacles 36, 42, respectively.

### INDUSTRIAL APPLICABILITY

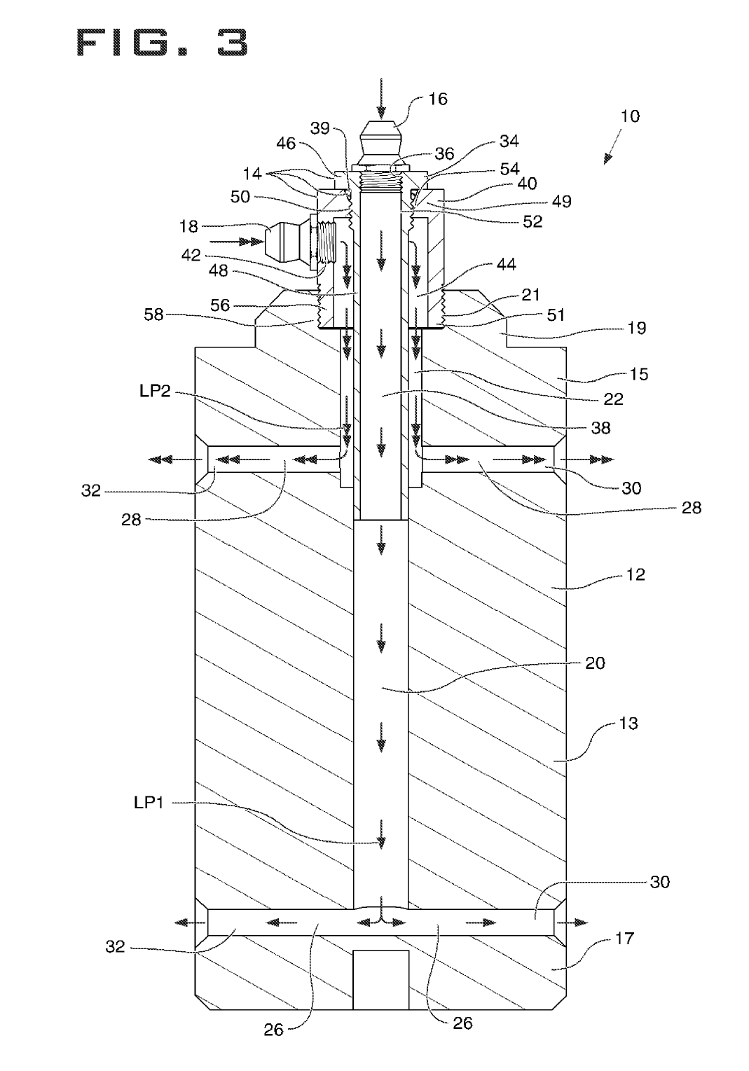

The swing pin assembly 10 is easily accessible for lubrication and enables lubricant to cover a substantial portion of the surface area of the pin cylinder 13 of the pin body 12. More specifically, the swing pin assembly 10 provides two zerks 16, 18 for injecting lubricant into two independent lubricant chambers 38, 44 and lubricant channels 20, 22, which in turn direct lubricant through two independent pairs of lubricant outlets 26, 28 spaced apart from one another on the pin cylinder 13. Accordingly, the swing pin assembly 10 provides two substantially redundant lubricant paths “LP1”, “LP2” (FIG. 3, indicated by single-headed and double-headed arrows, respectively) that help maintain lubrication even in the event that individual lubricant chambers, lubricant channels, and/or lubricant outlets become clogged or otherwise functionally impaired. In this way, the swing pin assembly 10 helps reduce wear of the pin cylinder 13 and hardware engaging the pin cylinder 13, for instance a boom (not shown) of an excavator or backhoe loader (not shown).

The swing pin assembly 10 described herein could be altered in a variety of ways without departing from the scope of the invention. For instance, additional lubricant paths could be added, including additional zerks, lubricant chambers, lubricant channels, and/or lubricant outlets. Also, the relative spatial orientation of the lubricant paths could be varied, for instance by mounting the two zerks in substantially parallel or non-perpendicular relation to one another. Further, the zerks, the zerk mount, and the pin body could be wholly or partially integral with one another rather than being separate components. Most importantly, the precise scope of the invention may be discerned only with reference to the claims and is not limited to any embodiments or alternatives disclosed in the specification.

What is claimed is:

1. A swing pin assembly, comprising:
a pin body defining first and second lubricant channels;
a zerk mount attached to the pin body, wherein the zerk mount defines first and second zerk receptacles, a first lubricant chamber downstream from the first zerk receptacle and upstream from the first lubricant channel, and a second lubricant chamber downstream from the second zerk receptacle and upstream from the second lubricant channel.

2. A swing pin assembly according to claim 1, wherein the zerk mount comprises:
a first zerk receiver defining the first zerk receptacle and the first lubricant chamber; and
a second zerk receiver defining the second zerk receptacle and the second lubricant chamber.

3. A swing pin assembly according to claim 2, wherein the first zerk receiver removably engages the second zerk receiver.

4. A swing pin assembly according to claim 3, wherein the second zerk receiver removably engages the pin body.

5. A swing pin assembly according to claim 2, wherein the first zerk receiver is a hollow fastener comprising a head and a shank, wherein the first zerk receptacle is defined by the head and the first lubricant chamber is defined by the shank.

6. A swing pin assembly according to claim 2, wherein the second zerk receiver further defines a zerk receiver port for receiving the first zerk receiver.

7. A swing pin assembly according to claim 6, wherein the first zerk receiver is inserted through the zerk receiver port and the second lubricant chamber defined by the second zerk receiver.

8. A swing pin assembly according to claim 7, wherein the first lubricant chamber and the second lubricant chamber are concentric and the cross-sectional area of the first lubricant chamber is less than the cross-sectional area of the second lubricant chamber.

9. A swing pin assembly according to claim 1, wherein the first lubricant channel is in fluid communication with a first lubricant outlet defined by the pin body and the second lubricant channel is in fluid communication with a second lubricant outlet defined by the pin body.

10. A swing pin assembly according to claim 9, wherein the first lubricant outlet is one of two opposing lubricant outlets in fluid communication with the first lubricant channel and the second lubricant outlet is one of two opposing lubricant outlets in fluid communication with the second lubricant channel.

11. A swing pin assembly, comprising:
a pin body defining first and second lubricant channels;
a zerk mount attached to the pin body, wherein the zerk mount defines first and second zerk receptacles, a first lubricant chamber downstream from the first zerk receptacle and upstream from the first lubricant channel, and a second lubricant chamber downstream from the second zerk receptacle and upstream from the second lubricant channel;
the zerk mount comprising
a first zerk receiver defining the first zerk receptacle and the first lubricant chamber, and
a second zerk receiver defining the second zerk receptacle and the second lubricant chamber, wherein the second zerk receiver defines a zerk receiver port for receiving the first zerk receiver, the first zerk receiver removably engages the second zerk receiver, and the second zerk receiver removably engages the pin body.

12. A swing pin assembly according to claim 11, wherein the first zerk receiver is a hollow fastener comprising a head and a shank, wherein the first zerk receptacle is defined by the head and the first lubricant chamber is defined by the shank.

13. A swing pin assembly according to claim 11, wherein the first zerk receiver is inserted through the zerk receiver port and the second lubricant chamber defined by the second zerk receiver.

14. A swing pin assembly according to claim 13, wherein the first lubricant chamber and the second lubricant chamber are concentric and the cross-sectional area of the first lubricant chamber is less than the cross-sectional area of the second lubricant chamber.

15. A swing pin assembly according to claim 11, wherein the first lubricant channel is in fluid communication with a first lubricant outlet defined by the pin body and the second lubricant channel is in fluid communication with a second lubricant outlet defined by the pin body.

16. A swing pin assembly according to claim 15, wherein the first lubricant outlet is one of two opposing lubricant outlets in fluid communication with the first lubricant channel and the second lubricant outlet is one of two opposing lubricant outlets in fluid communication with the second lubricant channel.

17. A method for assembling a swing pin assembly, comprising:
attaching a zerk mount to a pin body defining first and second lubricant channels, wherein the zerk mount defines first and second zerk receptacles, a first lubricant chamber downstream from the first zerk receptacle and upstream from the first lubricant channel, and a second lubricant chamber downstream from the second zerk receptacle and upstream from the second lubricant channel; and
securing first and second zerks in the first and second zerk receptacles, respectively.

18. A method according to claim 17, wherein the zerk mount in the attaching step comprises a first zerk receiver defining the first zerk receptacle and the first lubricant chamber and a second zerk receiver defining the second zerk receptacle, the second lubricant chamber, and a zerk receiver port for receiving the first zerk receiver, and the method further comprises securing the first zerk receiver in the zerk receiver port defined by the second zerk receiver.

19. A method according to claim 17, wherein the first lubricant channel defined by the pin body in the attaching step is in fluid communication with a first lubricant outlet defined by the pin body and the second lubricant channel defined by the pin body is in fluid communication with a second lubricant outlet defined by the pin body.

20. A method according to claim 19, wherein the first lubricant outlet is one of two opposing lubricant outlets in fluid communication with the first lubricant channel and the second lubricant outlet is one of two opposing lubricant outlets in fluid communication with the second lubricant channel.
